(19) United States
(12) Patent Application Publication
(10) Pub. No.: US 2025/0317777 A1
(43) Pub. Date: Oct. 9, 2025

(54) METHODS AND NETWORK ENTITIES FOR MITIGATING INTERFERENCE IN A BASE STATION SYSTEM

(71) Applicant: Telefonaktiebolaget LM Ericsson (publ), Stockholm (SE)

(72) Inventors: André Mendes Cavalcante, INDAIATUBA (BR); Igor Almeida, INDAIATUBA-SP (BR); Eduardo Lins de Medeiros, BROMMA (SE); Miguel Berg, SOLLENTUNA (SE)

(21) Appl. No.: 18/866,702

(22) PCT Filed: Jun. 3, 2022
(86) PCT No.: PCT/SE2022/050544

§ 371 Date: Nov. 18, 2024

(51) Int. Cl. H04W 24/10

(52) U.S. Cl. CPC H04W 24/10

(57) ABSTRACT

Disclosed is a method for mitigating intercell interference experienced in a distributed base station system comprising a Digital Unit (DU), a Hub, and a plurality of Radio Heads (RH) connected to the Hub via a fronthaul connection. The plurality of RHs comprises a first set logically arranged in a first cell and a second set logically arranged in a second cell. The method comprises obtaining, for individual of the first set of RHs, interference information on estimated interference experienced in an area served by the individual of the first set of RHs from signals sent by the plurality of RHs excluding the first set of RHs, determining, based on the obtained interference information, that a first RH of the first set of RHs suffers from intercell interference, and initiating change of the logical arrangement of the first RH from the first cell to the second cell.

### TECHNICAL FIELD

The present disclosure relates generally to methods, and network entities for mitigating intercell interference experienced in a distributed base station system. The present disclosure further relates to computer programs and carriers corresponding to the above methods and entities.

### BACKGROUND

In wireless communication networks there is a constant demand for higher data rates and thereby increased throughput over the wireless communication interface between a wireless communication device, also known as wireless device or a User Equipment (UE), and a base station, also known as a network node.

One way to increase throughput, especially in densely populated areas such as in cities, is to apply so called distributed base station systems. In a distributed base station system, a network node is split into separate units: a Digital Unit (DU) and a plurality of Radio Heads (RH) communicatively connected to the DU via a fronthaul connection. Traditionally, the DU performs advanced radio coordination features such as joint detection, joint decoding, coordinated multi-point transmission (COMP), to increase the spectrum efficiency and network capacity, as well as baseband processing, whereas the RHs perform radio frequency (RF) processing and wireless transmission/reception of the RF processed signals to from the UEs. By such a split, where the RHs have little functionality, it becomes possible to distribute high data rates in small areas to a comparatively low cost despite the numerous RHs.

An example of use of such a distributed base station system is as an indoor system. For indoor base station systems, the RHs are distributed at certain locations at each floor of a building. Typically, the RHs are installed at the ceiling, in fixed locations determined to maximize coverage but subject to limitations regarding where equipment can be mounted.

Each RH can have multiple antennas, e.g., to support Multiple Input Multiple Output (MIMO) techniques and diversity. An RH can sometimes be called Transmit/Receive Point (TRP), Radio Unit (RU) or O-RAN Radio Unit (O-RU). To save baseband processing capacity, it can be an advantage to aggregate multiple RHs in a hub. The hub may also be called an Indoor Radio Unit (IRU), or Fronthaul Multiplexer (FHM). If protocol/interface conversion is done in the hub, e.g., between Common Public Radio Interface (CPRI) and enhanced CPRI (eCPRI), it can also be called a Fronthaul Gateway.

FIG. 1 illustrates an example of a distributed base station system that has hubs used for aggregation of multiple RHs. The base station system 110 of FIG. 1 comprises a DU 160 communicatively connected to a first hub 130, a second hub 140 and a third hub 150. The DU 160 performs baseband processing. The base station system 110 further comprises a first set of RHs 131-134, a second set of RHs 141-144 and a third set of RHs 151-154. The first set of RHs 131-134 is arranged to provide coverage in a first cell 135, for which reason the RHs of the first set are distributed in the first cell 135. The first cell 135 may cover a first floor of a building. The first set of RHs 131-134 is communicatively connected to the first hub 130 over a fronthaul connection. The second set of RHs 141-144 is arranged to provide coverage in a second cell 145, for which reason the RHs of the second set are distributed in the second cell 145. The second cell 145 may cover a second floor of a building. The second set of RHs 141-144 is communicatively connected to the second hub 140 over a fronthaul connection. The third set of RHs 151-154 is arranged to provide coverage in a third cell 155, for which reason the RHs of the third set are distributed in the third cell 155. The third cell 155 may cover a third floor of a building. The third set of RHs 151-154 is communicatively connected to the third hub 150 over a fronthaul connection. The RHs of one set typically transmit the same downlink (DL) signal towards the UE, and in uplink (UL), the hub of that set combines signals received from the RHs of the same set. This type of transmission scheme results in good coverage with even distribution of receive (Rx) power over the coverage area, i.e., the cell. The hub essentially provides coverage in its cell, which is a cell or sector in the wireless communication network, implemented with distributed, always-on antennas of the RHs. Further, the fronthaul connection between the first, second and third set of RHs 131-134, 141-144, 151-154 and its respective hub 130, 140, 150 is realized by a digital interface, i.e., as a network 170. The network 170 may be an Ethernet-based network comprising Ethernet switches (marked with X in FIG. 1). By realizing the fronthaul connection with such a digital interface between the set of RHs and the hubs, the physical and logical connections between those nodes need not be the same.

FIG. 2 shows another type of distributed base station system 210 built on Open Radio Access Network (O-RAN). In O-RAN Open Fronthaul, sometimes called O-RAN Lower Layer Split (O-LLS), there is a concept called Shared Cell, where multiple O-RAN Radio Units (O-RUs) 231-234 are associated/connected to an FHM 230 in a star topology via fronthaul connections 271-274. The multiple O-RUs comprises a first set of O-RUs 231-232 and a second set of O-RUs 233-234. The first set of O-RUs 231-232 is arranged to provide coverage in a first cell 240, for which reason the O-RUs of the first set are distributed in the first cell 240. The second set of O-RUs 233-234 is arranged to provide coverage in a second cell 250, for which reason the O-RUs of the second set are distributed in the second cell 250. The O-RUs of one cell typically transmit the same downlink (DL) signal and the FHM combines signals from the O-RUs in uplink (UL). This type of transmission scheme results in good coverage with even distribution of receive (Rx) power over the coverage area. Further, a set of FHMs 230 are connected to a O-RAN Distributed Unit (O-DU) 260 where baseband processing is performed. In O-RAN Shared Cell, the basic mode of operation is “always on” for all the O-RUs in the Shared Cell, which means unnecessarily high DL and UL interference since a UE is often only within coverage of a few O-RUs. However, optional functionality has been added to the O-RAN Control-User-and Sync-(CUS)-plane specification to allow muting of O-RUs. This is called “Selective transmission and reception using beamld”.

In deployments such as in FIG. 1 and FIG. 2, loss of performance due to coverage holes or excessive interference may still occur. In other words, it is experienced in such deployments that in some parts of cells there is high intercell interference. Consequently, it is a need to mitigate such high intercell interference in order to increase total throughput of the distributed base station system.

### SUMMARY

It is an object of the invention to address at least some of the problems and issues outlined above. It is an object of embodiments of the invention to mitigate intercell interference experienced in distributed base station systems. It is possible to achieve these objects and others by using methods and network entities as defined in the attached independent claims.

According to one aspect, a method is provided that is performed by one or more network entities of a wireless communication network. The communication network comprises a base station system that comprises a Digital Unit (DU), a Hub, and a plurality of Radio Heads (RH). The Hub is connected to the DU. The plurality of RHs are connected to the Hub via a fronthaul connection. Further, the plurality of RHs comprises a first set of RHs logically arranged in a first cell and a second set of RHs logically arranged in a second cell. The method comprises obtaining, for individual of the first set of RHs, interference information on estimated interference experienced in an area served by the individual of the first set of RHs from signals sent by the plurality of RHs excluding the first set of RHs. The method further comprises determining, based on the obtained interference information, that a first RH of the first set of RHs suffers from intercell interference, and initiating change of the logical arrangement of the first RH from the first cell to the second cell.

According to another aspect, a one or more network entities is provided, configured to operate in a wireless communication network. The communication network comprising a base station system that comprises a DU, a Hub, and a plurality of RHs. The Hub is connected to the DU. The plurality of RHs are connected to the Hub via a fronthaul connection. The plurality of RHs comprise a first set of RHs logically arranged in a first cell and a second set of RHs logically arranged in a second cell. The one or more network entities comprises a processing circuitry and a memory. Said memory contains instructions executable by said processing circuitry, whereby the one or more network entities is operative for obtaining, for individual of the first set of RHs, interference information on estimated interference experienced in an area served by the individual of the first set of RHs from signals sent by the plurality of RHs excluding the first set of RHs. The one or more network entities is further operative for determining, based on the obtained interference information, that a first RH of the first set of RHs suffers from intercell interference, and initiating change of the logical arrangement of the first RH from the first cell to the second cell.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic diagram of a distributed base station system in which the present invention may be used.

FIG. 2 is a schematic block diagram of another distributed base station system in which the present invention may be used.

FIG. 3 is a schematic block diagram of a wireless communication network in which the present invention may be used.

FIG. 4 is a flow chart illustrating a method performed by one or more network entities, according to possible embodiments.

FIG. 5 is a schematic block diagram illustrating an RH handover, according to possible embodiments.

FIG. 6 is a flow chart illustrating a method according to possible embodiments.

FIG. 7 is a schematic block diagram illustrating a scenario with cells and RHs in which the present invention may be used.

FIG. 8 is a schematic sketch of three cells and RHs in those cells in which the present invention may be used.

FIG. 9 is a block diagram illustrating one or more network entities in more detail, according to further possible embodiments.

### DETAILED DESCRIPTION

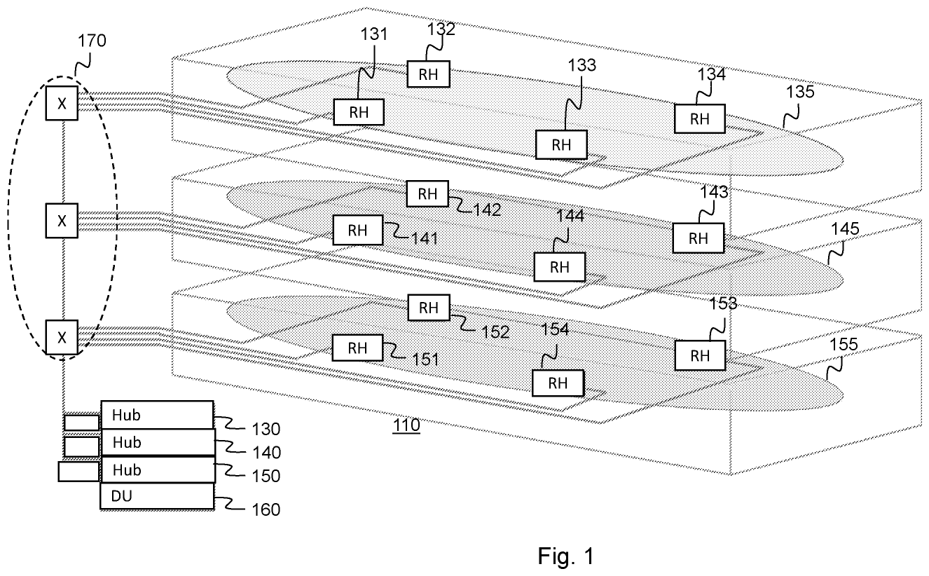

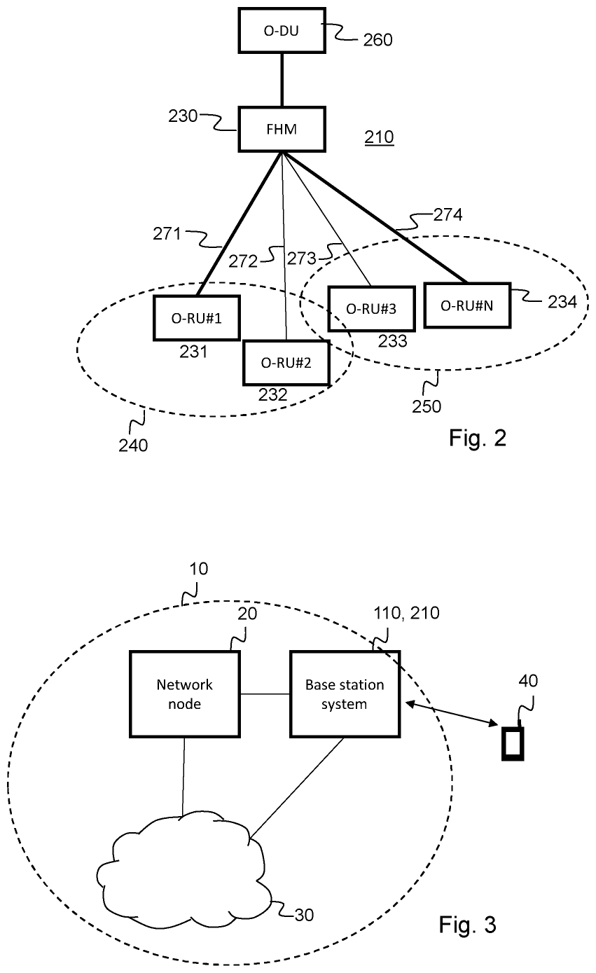

Briefly described, a solution is provided to reduce intercell interference in a distributed base station system such as the ones shown in FIGS. 1 and 2. Embodiments of the solution is built on identifying RHs experiencing high intercell interference, or actually areas where RHs are situated in which there is a high intercell interference, and then logically move the RH experiencing high interference to a neighboring cell in order to thereby achieve that UEs experience less interference throughout the cell coverage area. When for example looking at the system described in FIG. 1, it may be so that one RH situated in the first cell 135, for example RH 131, is radio-wise closer to one or more of the RHs 141-144 of the second cell 145 than the other RHs 132-134 of the first cell 135, even though the exemplary RH 131 is arranged on the same floor as the other RHs 132-134 of the first cell 135. This could be determined by measuring or obtaining the intercell interference experienced at the individual RHs of the first cell. From such measured or obtained intercell interference of the different RHs, the exemplary RH 131, hereinafter called a first RH, is determined to experience the highest intercell interference from the second cell 145. By moving the first RH 131 from the first cell 135 to the second cell 145, the intercell interference that the first RH 131 would experience would be lowered, and probably the total intercell interference experienced by the distributed base station system 110 of FIG. 1 would be reduced. Such moving of the first RH 131 would not be a physical movement but a change of the logical arrangement of the first RH from the first cell 135 to the second cell 145. In other words, the logical arrangement of the first RH would be changed from the first hub 130 to the second hub 140. In other words, the procedure identifies one or more RH in one cell with compromised coverage employing inter-cell interference measurements, and establishes an appropriate RH-Hub association, i.e., a reconfiguration of the one or more RHs, to reduce the inter-cell interference. Concerning the network topology, this reconfiguration is intended to be seamless, requiring only changing e.g., destination addresses or packet routes in each node involved in the reconfiguration.

A similar procedure may be applicable for the base station system described in FIG. 2 as well, calling the O-RUs 231-234 for RHs and the FHM 230 for a hub as well as the O-DU 260 for a DU.

FIG. 3 shows a wireless communication network 10 comprising the distributed base station system 110 of FIG. 1 or the distributed base station system 210 of FIG. 2. The wireless communication network 10 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network. The wireless communication network 10 further comprises other network nodes, illustrated by another network node 20 which is connected to the base station system 110, 210. The wireless communication network 10 may further comprise or be connected to a cloud computing network 30.

A UE 40 is further shown, which is arranged for wireless communication with the base station system 110, 210, via the RHs of the base station system. For example, the UE may be a machine-type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE), an Internet of Things (IoT) device, etc.

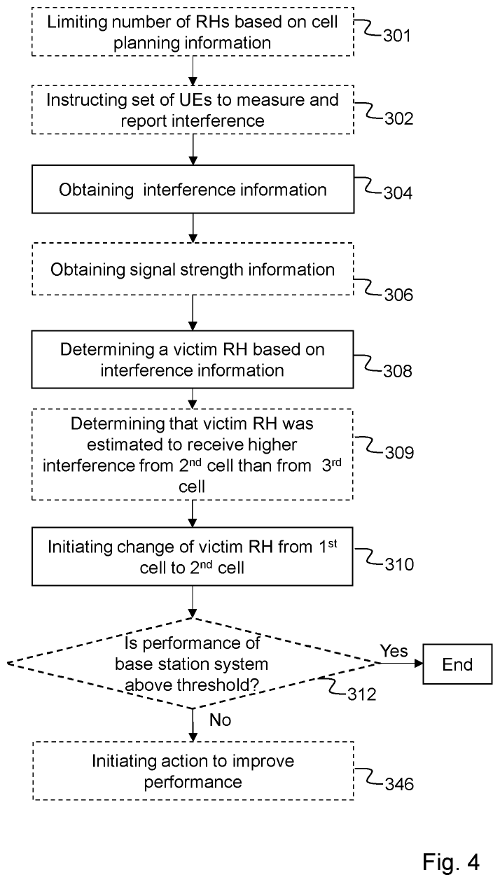

FIG. 4, in conjunction with FIG. 1 or FIG. 2, shows a method performed by one or more network entities of a wireless communication network. The communication network comprises a base station system 110; 210 that comprises a Digital Unit (DU) 160; 260, a Hub 130, 140, 150; 230, and a plurality of Radio Heads (RH) 131-134, 141-144, 151-154; 231-234. The Hub 130, 140, 150; 230 is connected to the DU 160; 260. The plurality of RHs 131-134, 141-144 151-154; 231-234 are connected to the Hub 130, 140, 150; 230 via a fronthaul connection 170; 271-274. Further, the plurality of RHs comprises a first set 131-134; 231-232 of RHs logically arranged in a first cell 135; 240 and a second set 141-144; 233-234 of RHs logically arranged in a second cell 145; 250, The method comprises obtaining 304, for individual of the first set of RHs 131-134; 231-232, interference information on estimated interference experienced in an area served by the individual of the first set of RHs 131-134; 231-232 from signals sent by the plurality of RHs excluding the first set of RHs. The method further comprises determining 308, based on the obtained 304 interference information, that a first RH of the first set of RHs suffers from intercell interference, and initiating change 310 of the logical arrangement of the first RH from the first cell 135; 240 to the second cell 145; 250. The initiation of change 310 of the first RH from the first cell to the second cell is performed as a result of the determination 308.

The one or more network entities that perform the steps of the method, i.e. the obtaining 304, the determining 308 and the initiation change 310 may be part of the DU 160; 260. Alternatively, the one or more network entities may be arranged in another node of the wireless communication network, such as the network node 20 of FIG. 3. Still alternatively, the one or more network entities may be realized as a group of network nodes, wherein functionality of the one or more network entities is spread out over the group of network nodes. The group of network nodes may be different physical, or virtual, nodes of the network. The group of network nodes may be part of a cloud computing network, such as the network 30 of FIG. 3. In the system of FIG. 1, there is normally one hub per cell. In the O-RAN-based system of FIG. 2, there is normally one FHM 230 handling all cells but logically there is one functionality per cell.

The fronthaul connection may comprise dedicated fronthaul links between a single hub and each of the plurality of RHs. Alternatively, the fronthaul connection may be a fronthaul network. In the alternative of FIG. 1, the fronthaul connection 160 is preferably realized as a fronthaul network whereby it is possible to move the RHs between different cells managed by the different Hubs 130, 140, 150. In the alternative of FIG. 2, (O-RAN), there may be dedicated fronthaul links as here there may be one single hub (FHM 230) that manages all cells of the base station system, or at least one FHM could manage more than one cell. So, in both alternatives the reassociation is logical. But for the system of FIG. 1, the destination addresses are changed, e.g., in UL, which hub should receive packets from which RH, and for the O-RAN case, the FHM 230 is told which streams it should combine in the UL. Of course, the fronthaul connection could be realized as a network also for the O-RAN alternative of FIG. 2.

The one or more entities may obtain information on the estimated interferences from the respective RH. The actual estimation of interference may be performed from interference measurements performed by the RHs or by UEs connected to the RHs. The estimated interference is an estimate for how the interference is in an area covering where the RH is situated, it may be interference in the actual position of the RH, which it will be if the RH performs interference measurements on DL signals from RHs of other cells, or interference in an area where the RH provides coverage, which it will be if UEs connected to the RH makes the interference measurements.

By such a method, it is possible to rearrange the cell arrangement of the RHs of the first set so that an RH, here called first RH, experiencing the highest intercell interference of the first set of RHs, i.e., interference from RHs of another cell than the first cell, can be logically arranged to the second cell. In the second cell, the first RH may now receive lower intercell interference than when it was in the first cell, which results in a total lower intercell interference in the base station system and therefore a better throughput of the base station system. It may be so that even if it seemed from geographical arrangement that the first RH should belong to the first cell, for example together with RHs arranged at the same floor of a building, the first RH is more closely connected to RHs of another floor of the building, which are logically arranged in the second cell, when it comes to wireless transmission capabilities. Thanks to this method, such logical rearrangement can be performed in the base station system.

According to an embodiment, for each of the individual of the first set of RHs 131-134; 231-232 the interference information is based on interference estimated by a set of UEs being in the area served by the individual of the first set of RHs 131-134; 231-232 on signals sent from the plurality of RHs excluding the first set of RHs and received at the set of UEs.

In other words, for each RH of the first set, measurements are used that are made by a set of UEs that are in the RH's served area. This set of UEs, which should be different for different RHs of the first set, estimate(s), i.e., measure(s), interference on signals it/they receive from RHs outside the first cell. It may be so that the set of UEs for different of the individual RHs of the first set are exclusively different, i.e. one UE only belongs to one set, i.e. one RH, but as the UEs may be in range of more than one RH simultaneously, a UE may be part of sets of UEs of different RHs of the first cell. In case the individual RHs of the first cell are not capable of measuring intercell interference, i.e., DL interference on signals sent from RHs of other cells, by themselves, it was found out that intercell interference experienced by UEs that are in the area served by the individual RH would also be a good estimation of the interference experienced in the area served by the individual RH. In this case, the UEs report measured intercell interference to the one or more network entities. So, the information the one or more network entities obtains comprises the intercell interference that the UEs measured.

According to another embodiment, the signals sent by the plurality of RHs excluding the first set of RHs and onto which the interference is measured by the set of UEs are sent in first communication resources defined as first Channel State Information-Interference Measurement (CSI-IM) resources in the first cell. Further, the method comprises instructing 302 the set of UEs to measure interference on the first CSI-IM resources and to report the measured interference on the first CSI-IM resources to the one or more network entities. Also, the obtained 304 interference information comprises the measured interference reported on the first CSI-IM resources.

The CSI-IM communication resources are certain time-frequency resources on which the RHs of the own cell is to be quiet. In order for the UEs to be able to measure on the CSI-IM resources, they are instructed to do such measurement and are informed where those resources are in time and frequency. By using CSI-IM resources, there will only be signals originating from neighbor cells in the cell, so interference measurements can be made with better quality than if signals are simultaneously sent by any of the RHs of the own cell.

According to another embodiment, the method further comprises, for individual of the first set of RHs, obtaining 306 signal strength information on an estimation on received signal strength for signals sent between individual of the set of UEs and the individual of the first set of RHs 131-134; 231-232. Further, the determining 308 that the first RH suffers from intercell interference is based on the obtained 304 interference information and the obtained 306 signal strength information.

In this embodiment, not just experienced interference at a set of UEs is taken into consideration for determining which RH is the first RH but also the signal strength of signals sent between the actual RH and each of the set of UEs. The signal strength can be used as an estimation of the distance between the certain RH and the UE. Signal strength for a signal sent either from the UE to this RH, UL signals, or from the RH to its UE, DL signals, can be used to determine the estimation of distance. Based on the estimated signal strength and the estimated interference at the UE, one or more representative UEs maybe selected out of the set of UEs that seems to be good representatives for the interference experienced by the respective RH of the first set of RHs. The signals sent between individual of the set of UEs and the individual of the first set of RHs may be reference signals, such as Sounding Reference Signals (SRS) for UL.

According to an embodiment in which the UEs measure the signal strength on signals sent DL from an RH, the method further comprises instructing the set of UEs to measure signal strength at certain communication resources and to report the measured signal strength to the one or more network entities. Also, for this embodiment, the RHs of the first set are instructed by the one or more network entities to transmit DL reference signals one RH at a time. In other words, a first RH of the first set is instructed to send DL reference signals in the first cell at first of the certain communication resources and the other RHs of the first set are instructed not to transmit any signals at the first communication resource. Similarly, a second RH of the first set is instructed to send DL reference signals at a second of the certain communication resources and the other RHs of the first set are instructed not to transmit any signals at the second communication resource. Hereby, the reported signal strength measured by the UE will only be affected by one RH at a time.

According to another embodiment in which the RHs of the first set each measures the signal strength on signal sent UL from the UEs, the method further comprises either instructing the first set of RHs to listen to a certain UE one RH at a time or that the signal acquired at each RH is processed separately. The purpose is for the network entities to determine or extract signal strength measurements for individual RHs.

According to another embodiment, the interference information for the individual of the first set of RHs 131-134; 231-232 is based on interference estimated by the individual of the first set of RHs 131-134; 231-232 on the signals sent from the plurality of RHs excluding the first set of RHs.

Such an embodiment would provide an accurate information on interference at the respective RH of the first set, which is simpler and that may provide a better estimate of the interference situation in the area covered by that RH than to estimate interference via the UEs that are estimated to be in the area covered by the RH. However, it requires that the RHs can be configured for receiving signals during a downlink slot of a neighbor cell.

According to another embodiment, the plurality of RHs further comprises a third set 151-154 of RHs logically arranged in a third cell 155 (see FIG. 1, however it might also be applicable to the system of FIG. 2 even though no such third set of RHs is explicitly shown in FIG. 2). The method further comprises determining 309, based on the obtained interference information, that the first RH was estimated to receive higher interference from the second set of RHs 141-144; 233-234 than from the third set of RHs 151-154. Further, the initiating of change 310 of the logical arrangement of the first RH from the first cell 135; 240 to the second cell 145; 250 is performed based on the determination 309 that the first RH was estimated to receive higher interference from the second set of RHs 141-144; 233-234 than from the third set of RHs 151-154. In other words, it is determined that the first RH was estimated to receive higher intercell interference from the second cell than from the third cell. Thereafter, the initiating of change of the first RH to the second cell is performed based on this determination. On the other hand, there may be other information influencing to which of the cells to move the first RH out of which the cell that provides the highest intercell interference to the first RH, such as how many RHs the second and third cell already have, or if the first RH has been moved around much recently. For example, the one or more network entities may have tried recently to move the first RH to the second cell 145; 250 without success. In that case, it may be decided anyhow to move the victim RH to the third cell 155 instead, or to let it stay in the first cell 135; 240.

According to another embodiment, the method further comprises, after the initiation of change 310 of the logical arrangement of the first RH from the first cell 135; 240 to the second cell 145; 250, determining 312 whether performance of the base station system is a above a threshold, and in case the performance of the base station is determined to be below the threshold, initiating 314 an action with the aim to improve performance. After changing the logical arrangement of the first RH, it is appropriate to determine whether the actual performance for the base station system was increased or not. The performance that is evaluated in the determining step could be e.g. cell capacity for the first and the second cell. The threshold may be a comparison to previous cell capacities. The action could be to move the first RH back to its original cell or to move the first RH to another cell.

According to another embodiment, there are more RHs than the first set of RHs in the first cell 135; 240. Further, the first set of RHs are the RHs of the first cell that lie closer to the cell border than the other RHs of the first cell. Then the method further comprises, before the obtaining 202 of interference information, limiting 201 a number of RHs of the first cell onto which to obtain interference information to the first set of RHs, based on cell planning information of the first cell.

For some cells there may be quite a large amount of RHs in one cell which could make the determination of a victim cell a computing resource demanding and/or communication resource demanding task. In order to limit the amount of RHs on which to determine a first RH, and thereby save such resources, the number of RHs of the first cell on which to determine a first RH and thereby request interference measurements for, may be limited to the RHs that lie closest to the cell border. Information on the position of the RHs may be taken from cell planning information.

Embodiments of the invention relates to a shared cell deployed under a digital/packetized fronthaul interface, for example an Ethernet-based network, between Radio Heads (RH) and Hubs. The baseband unit, i.e. the DU, evaluates an interference figure of merit for each RH and/or Hub in order to determine an appropriate RH-Hub association that promotes reduction on the system inter-cell interference. FIG. 1 illustrates a possible considered scenario.

First some background definitions: “Victim cell” signifies a cell considered as suffering interference, the victim cell may also be called “first cell”; “Aggressor cell” signifies a cell considered as source of interference; “Victim RH” signifies an RH in the victim cell during interference measurement; “Non-zero Power Channel State Information-Reference Signals (NZP CSI-RS)” signifies reference signals used for e.g., getting channel measurements from a serving cell; “Zero Power Channel State Information-Reference Signals (ZP CSI-RS)” signifies reference signals defined by zero power resource elements (REs) where physical downlink shared channel (PDSCH) is not mapped, and the UE cannot make any assumptions of the content of these resources; “Channel State Information-Interference Measurement (CSI-IM)” signifies reference signals used for getting direct interference measurements from samples. Observe that although CSI-IM resources practically contain zero power REs, CSI-IM and ZP CSI-RS are used for different functions, i.e., CSI-IM for interference measurement and ZP CSI-RS for any other specific purpose; “Single Frequency Network (SFN)” signifies transmission mode where the same information, including reference signals, is transmitted by all transmission points of a cell. It is the default implementation for O-RAN Shared Cell and RDS.

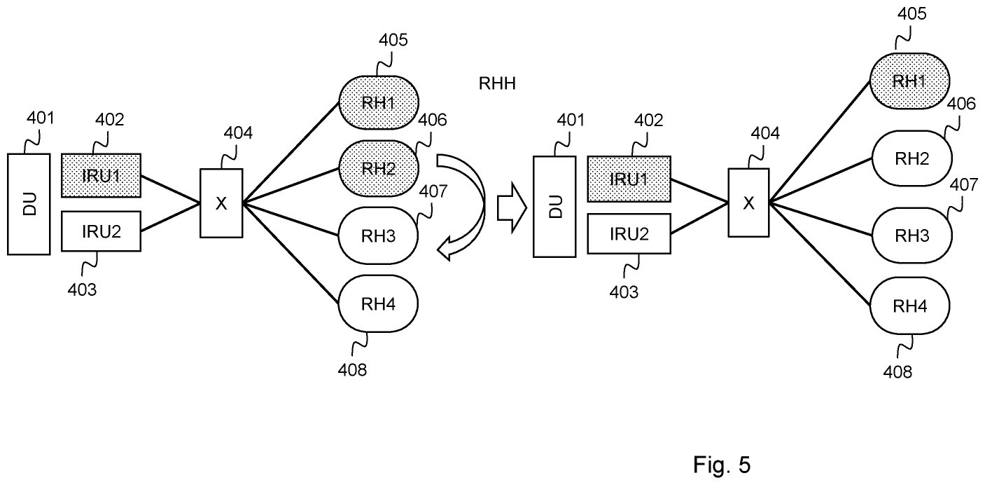

One basic re-association mechanism that is considered to improve performance indicators of the base station system, i.e., less interference and higher throughput, etc., is shown in FIG. 5. The re-association mechanism is hereby called a Radio Head Handover (RHH). The left part of FIG. 5 shows an RDS before an RHH and the right part the same RDS but after the RHH. The RDS comprises a DU 401, a first and a second IRU (aka Hub) 402, 403, a fronthaul connection 404, which may be an Ethernet-based network, and four RHs: RH1 405, RH2 406, RH3 407 and RH4 408. Before the RHH, RH1 405 and RH2 406 are associated with the first IRU 402, which is illustrated in FIG. 5 by those units having a dotted pattern. Further, before the RHH, RH3 407 and RH4 408 are associated with the second IRU 403, which is illustrated by those units having no pattern. The RHH works like this: A donor Hub, here the first IRU 402 triggers in this case RH2 406 to, at some point in the future, re-associate itself to a receiver Hub, here the second IRU 403. For an RDS, the RHH may also be called Dot Handover (DH). After the RHH, the RH2 406 is now associated to the second IRU 403, as illustrated by its changed pattern (or deletion of dotted pattern) in the right part of FIG. 5.

An “O-RU handover” would be the equivalent reassociation action as the RHH but in an O-RAN Shared Cell scenario as illustrated in FIG. 2. When performed, the (possibly virtual) O-DU responsible for the neighbor cell will then start communicating with the donated O-RU. This might be accomplished by signaling the FHM node such that the signal for the donated O-RU is combined in the context of the neighbor cell rather than the original one.

In the following, a first embodiment of a method according to the invention is presented. The method comprises, for victim RHs along cell borders of a victim cell, measure interference from neighbor cells. Thereafter, based on the measured interference, one or more RHs suffering significant interference, called first RH, is selected. Then, the cell association of the first RH is reconfigured so that the first RH belongs to one of the neighbor cells instead of to the victim cell. Here it is assumed that UEs at the edges of the victim cell will experience higher downlink interference from neighboring cells than UEs situated further away from the cell edges, i.e., more to the middle of the victim cell. In other words: without extensive coordination between schedulers, the used resource blocks in a neighbor cell may coincide with those allocated to UEs at the cell edge of the victim cell. Further, it is assumed that RH(s) at the edges of the cell are the primary serving RHs for the UEs mentioned above. Unlike a standard three-sector deployment with a centralized tower, coverage in a shared cell is expected to be more uniform due to their distributed nature, and the term “cell edge” should not be confused with regions having lower signal power. With these assumptions in place, it is observed that the coverage area of a single RH that happens to lie along a cell edge will be more impacted by the simultaneous transmissions of a neighbor cell; and that UEs in that coverage area, regardless of signal power, i.e., proximity to the relevant RH, should experience higher interference. Therefore, once such single RH, or first RH, can be identified as providing compromised coverage, one should decide whether it would be advantageous to have that single RH belong to one of the neighbor cells to the victim cell instead of to the victim cell. One scenario where this could occur is when the original deployment is effectively creating a “wedge” into the coverage area of a neighbor cell. That being the case, the method would trigger a reassociation of the single RH from the victim cell to that neighbor cell.

In the following, a second embodiment of the method is presented. An issue with the first embodiment of the method is that an RH may not be capable of measuring DL interference. In the second embodiment, this issue is tackled. The main assumption is that a UE near a candidate RH can be told to measure specific resource blocks reserved for CSI-IM. It will be discussed how to discover which UEs are near which RH(s) further down. The method of the second embodiment uses CSI-IM measurement reports as a proxy for signal power coming from neighbor cells, i.e., inter-cell interference. In the victim cell, CSI-IM is set to silence, i.e., zero-power CSI-RS, so that any power measurement reported by the UE must be coming from signals sent from other cells. It is important that neighbor cells of the victim cell keep transmitting normally during the CSI-IM measurement in the victim cell. Further, in case the victim cell has more than one neighbor cell, some coordination may be needed between the neighboring cells during this measurement step in order to be able to identify which neighbor cell is most “responsible” for the interference being measured by the UE. The method could function even if no coordination is performed between multiple neighboring cells, however it is not ideal because the next step, i.e. deciding whether an “RH handover” should be performed, requires a target cell for the first RH.

One way to isolate aggressors, i.e. to isolate neighbor cells or to coordinate neighbor cells, is to make sure only one neighbor cell is transmitting in the resource blocks that have been reserved for CSI-IM in the victim cell. This may be performed by the following: a) Given all neighbor cells of victim cell A, pick one neighbor cell at a time; b) Configure the picked neighbor cell to transmit CSI-RS on the RBs that cell A reserved for CSI-IM while all other neighbor cells and victim cell A should transmit silence on the RBs reserved for CSI-IM, such as CSI-IM using ZP CSI-RS; c) Perform signal strength measurement at the UEs on the CSI-RS each UE receives from the neighbor cells, then iterate. Methods for parallelizing those measurements will be discussed further down. Once several UEs have measured CSI-IM RBs along the cell borders, the affected RHs which, by our assumption, are close to one or more UEs, can be considered for reassociation, and the method proceeds.

In the following, a third embodiment of the method is discussed, in which it is further discussed how to associate interference measurements to nearby RHs. The method so far allows the identification of RHs in a victim cell whose coverage area may be compromised by neighboring cells, using UEs in the victim cell as probes for DL interference. We now tackle the problem of associating interference measurements with RHs being nearby the UEs used as probes. A main idea here is to have reference signals in the victim cell be sent from individual RHs of the victim cell, such that the measurement is unambiguously reported. Like in the second embodiment, the most straightforward approach for this is muting iteratively: a) Given candidate RHs of victim cell A, instruct one RH at a time to transmit reference signals so that each RH transmits in separate resource blocks, and mute all the other RHs of cell A, “muting” here should be understood in the context of the reference signal and not necessarily all transmissions from the other RHs; b) Request a regular CSI-RS measurement report from all, or some, UEs residing in the victim cell, or use periodic measurements if more convenient; c) Associate each measurement report with the active RH at the time of measurement, then iterate if necessary.

Note that, with this approach, each active RH is associated with several measurements-one from each UE that was requested to report. At the end of this embodiment, it is possible to identify which UE reports the highest signal power as the relevant UE for each RH-though other aggregating strategies are possible.

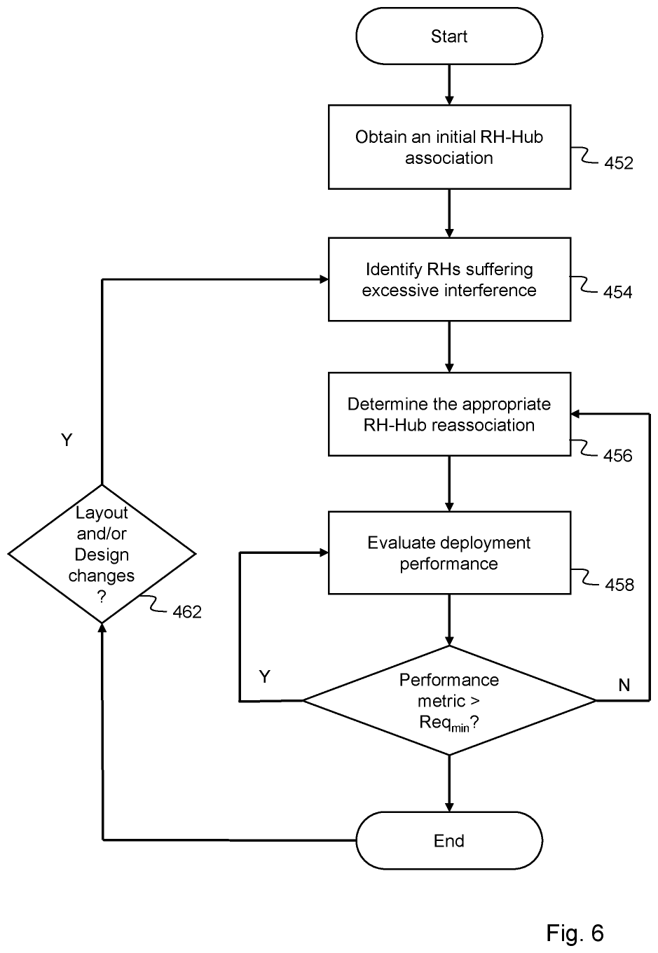

In the following, and with reference to FIG. 6, a fourth embodiment of the method is discussed. This embodiment starts by obtaining 452 an initial RH-Hub association. This may be performed based on deployment planning, i.e., from cell planning information of base station system. In general, the initial deployment obtaining is performed based on vendor/deployer guidelines and/or planning studies. Such guidelines are assumed to be the starting point for the RH-Hub reassociation procedure. The result will be, for each cell, a list of their associated RHs. The embodiment proceeds by identifying 454 RHs with compromised coverage in a selected victim cell, i.e., identifying RHs suffering excessive intercell interference. The identifying 454 comprises measuring or evaluating how each RH of a victim cell is harmed by its neighbor cells. As a shared cell adopts the SFN mode, this individual evaluation is non-trivial.

According to an embodiment, an interference measurement scheme is proposed that is based on two CSI reference signals defined in NR, i.e., CSI-RS and CSI-IM, to indirectly obtain an approximation of Signal-to-Noise-Ratio (SNR) and Interference Measurement (IM) for each RH in the victim cell. This scheme comprises the following: a) Define a pair of adjacent cells <victim_cell, aggressor_cell>. This can be supported by the Automatic Neighbor Relations (ANR) function already available in NR; b) For the victim_cell, the RHs that we are interested in getting interference measurements from, i.e., the victim_RH, is set to transmit both NZP CSI-RS and CSI-IM. The remaining RHs in the victim_cell are muted to guarantee that the SNR estimation relates to the victim_RH. c) Request UEs in the victim_cell to report two measurements. The first estimate (referred here as <snr_estimate>) is the SNR measurement obtained from NZP CSI-RS and the second one (referred here as <im_estimate>) is the IM report obtained from the CSI-IM. As result, we will have tables of UE measurements for each victim_RH in the victim_cell. As example, Table 1 below shows an illustration of UE measurements for a given victim_RH in a given victim_cell.

TABLE 1
victim_RH

| UEs inside a given | | |
|---|---|---|
| victim_cell | SNR | IM |
| UE 1 | 12 dB | −40 dBm |
| UE 2 | 7 dB | −50 dBm |
| . . . | . . . | . . . |
| UE m | 21 dB | −38 dBm |

According to an embodiment, one or more representative UE may be selected to identify which RH's coverage is compromised. One strategy for that is selecting a UE that has reported high values for both SNR and IM. A high SNR means that the UE is close to the victim_RH, and a high IM means the UE is suffering high interference from aggressor_cell. Note that any thresholds and/or rules over SNR and IM to select the representative UE are design parameters. If there are several UEs close, another strategy could be to select the several UEs and for example calculate an average of their IMs instead of only using IM from the UE with the highest SNR. Also, the procedure can be complemented and/or combined with other strategies, like Reference Signal Received Power (RSRP)-based or path loss estimation. At this point, all UEs, or all selected UEs, in the victim_cell have reported their measurements to the DU, so we proceed to enable a different victim_RH in the same cell and repeat the process (steps a-c in the paragraph immediately above). Once this process has been finalized for a given victim_cell, we will have a list of significant measurements for its RHs, as illustrated in Table 2:

TABLE 2

| victim_RH | SNR | IM |
|---|---|---|
| RH 1 | 21 dB | −38 dBm |
| RH 2 | 7 dB | −50 dBm |
| . . . | . . . | . . . |
| RH k | 16 dB | −65 dBm |

With the information provided by Table 2, it is enabled to, for example sort RHs by highest IM reports. This results in a list of candidate RHs for reassociation. The process can be repeated for another <victim_cell, aggressor_cell> pair if this is of interest. The strategy to select a new pair and when is also a design decision. As a result, for each victim cell, a list of RHs with compromised coverage, and which neighbor cell the RHs with compromised coverage may be moved to, can be presented.

The method according to the fourth embodiment, as described in FIG. 6, further comprises determining 456 the appropriate RH-Hub reassociation. At this point, RH(s) in each victim cell experiencing excessive interference from neighbor cells have been identified. In the determining 456, figures of merit can be used to determine which RH-Hub reassociations should be performed. Next, some strategies that could be employed are described. The “Highest-Interference” strategy comprises choosing, among all victim RHs, the RH that is experiencing the highest level of interference and hand it over to the responsible neighbor cell. A parameter for this strategy could be the maximum number of RHs allowed to be re-associated in a single iteration. An additional condition could be added so that, during a single measurement iteration, RH handovers only occur once per cell pair. This helps prevent cases where a victim cell “gets rid” of a problematic RH, only to receive another one from that neighbor when it is their turn to be the victim for the algorithm. The “Most-Interferers” strategy consists of choosing, in a single victim cell, the RH that experiences interference from the largest number of neighbors. The destination cell for the RH handover can still be defined based on highest interference level. As a result, for each cell, there may be a list of RHs entering or leaving.

The method according to the fourth embodiment further comprises evaluating 458 deployment performance. This means evaluating if the performed RH-Hub re-associations promoted improvements on the system performance. It can be done evaluating if some performance metric, e.g., SINR, cell capacity, etc., is higher than a defined minimum requirement (Reqₘᵢₙ). If the evaluating 458 shows a decrease in performance, or at least that the defined minimum requirement is not fulfilled the step of determining 456 appropriate RH-Hub reassociation can be triggered again using another RH-Hub reassociation. Otherwise, i.e., if the reassociations improved system performance, the method can remain in step 458 for a time interval or until it meets certain criteria. This performance control loop is useful to account for performance variations due to UE mobility. Once all defined requirements/criteria are met, the method is finalized. If any layout change occurs 462, or any other design pattern has been changed, the method can be restarted from the identifying 454 of RHs suffering excessive interference.

It should be noted that the embodiment for the O-RAN Shared Cell as shown in FIG. 2 is equivalent, with perhaps minor modifications pertaining to the FHM node's actions. For example, the selective transmission and reception sub-steps of the RH identifying 454 could be implemented by the FHM directly. Also, as already stated, the actual reassociation in the determining 456 affects only the logical connection between nodes, and therefore is accomplished by signaling the FHM node such that the signal for the donated O-RU is combined in the context of the neighbor cell rather than the original one.

Parallel interference measurement. One point of concern for the feasibility of this method could be the number of iterations required until the identifying 454 of RHs with compromised coverage is complete. As presented so far, every <victim_cell, aggressor_cell> pair requires K+1 measurements, one for each active RH, and one for the interference measurement, so the time complexity could be written as O(K*N), N being the average number of neighbors a cell can have. A possible improvement here is to have pre-determined CSI-IM configurations that span non-overlapping resource blocks, so that interference measurement requests can be sent to a subset of the UEs in the victim cell, such that interference from several aggressor cells can be measured simultaneously.

Reciprocity-based SNR measurement. An optional feature could be the use of uplink reference signals such as Sounding Reference Signals (SRS) to determine which UEs are closest to which RHs. Iterative activation of a single RH at a time is still required, unless the received uplink signal at the Hub is processed before combining. This would require that the Hub has a notion of the UE identities in order to separate their signals, or a at least temporary increase in uplink fronthaul data so that the uncombined RH streams can be processed at the baseband unit.

Direct measurements with RHs instead of UEs. According to an embodiment, the RHs themselves measure interference coming from neighbor cells. This requires, however, that an RH is configured for “uplink” during a downlink slot of a neighbor cell. In this embodiment, UEs are not necessary for measurement of the coverage area near an RH, so iterative muting is used to isolate individual RHs in the aggressor cell instead of in the victim cell. The method then continues normally. One can imagine scenarios where RHs can hear each other well, but where their coverage areas are not strongly interfered. One such example could be walls that do not go all the way up to the ceiling, allowing Line-of-Sight between RHs, but at least partially blocking signals to UEs from potentially interfering RHs. However, in many cases, RH to RH measurements can give a good indication of the interference. Further, RH to RH measurements are much faster than RH to multiple UEs and can be done more often. This allows the system to react quicker to changes in the environment, e.g., temporary walls or large furniture.

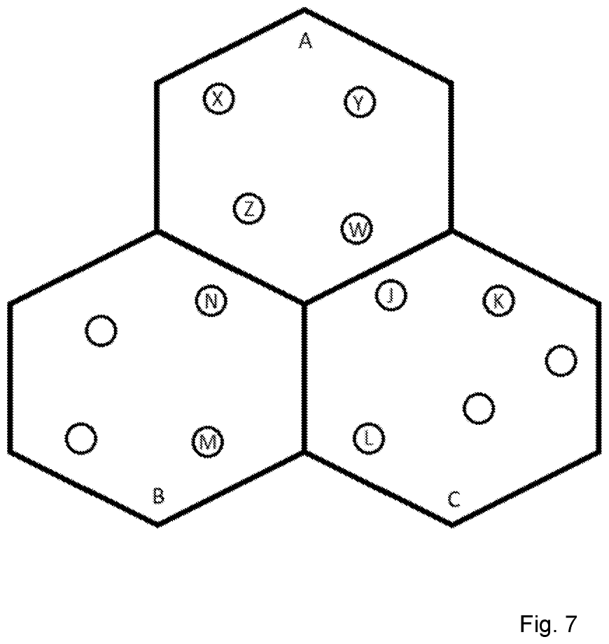

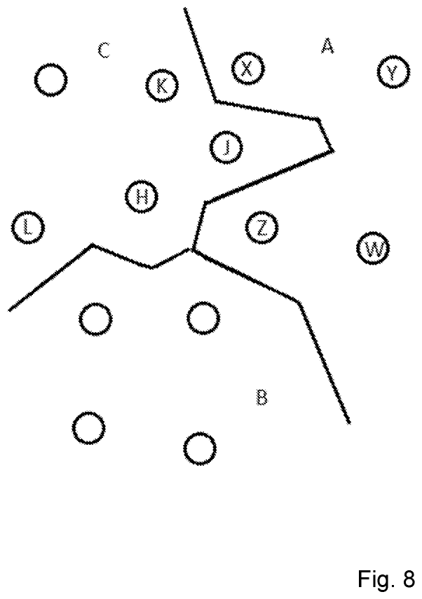

In the following, some possible scenarios are explored to illustrate some of the described embodiments. In the scenarios, which are shown in FIGS. 7 and 8, there are three different cells A, B and C. In the first and second scenario, both referring to FIG. 7, cell A has RH W, X, Y and Z, cell B has RH N and M, and cell C has RH J, K and L.

In the first scenario, a direct comparison of interference measurements are performed. Assuming there are enough UEs per cell to properly characterize the coverage area of each RH individually, for the deployment above the measurements shown in Table 3 were reported:

TABLE 3

| victim_RH | SNR | IM | |
|---|---|---|---|
| X | 39 dB | −118 | dBm |
| Z | 41 dB | −100 | dBm |
| W | 40 dB | −90 | dBm |
| N | 39 dB | −96 | dBm |
| M | 41 dB | −108 | dBm |
| J | 39 dB | −87 | dBm |
| K | 40 dB | −99 | dBm |
| L | 39 dB | −102 | dBm |

In these deployments, it is assumed that a given RH would be more significantly interfered by one specific cell out of all the current neighbors. In an embodiment, selection could be performed based on thresholds with respect to an acceptable absolute interference level, e.g., 10 dB above −100 dBm. In this embodiment, RHs W and J would be flagged, of which J is a clear choice. This is the Highest-interference strategy mentioned previously. In another embodiment, provided that the cell has enough RHs, the “acceptable interference level” could be calculated as an average, or the 50-th percentile, or some other similar metric, of the IM reports, perhaps taking into account past measurements, instead of being predetermined. Flagged RHs would be those whose IM reports are too far from this value. When IM reports have close values, some embodiments could include the number of RHs in a cell, such that cells with more RHs would be more likely to “donate” them to others

In the second scenario, measurement uncertainty is considered. In cases where the best SNR, as measured by the UE, for a particular RH is not high enough, the IM reports could be further scrutinized. Consider the deployment of FIG. 7 and the following measurement table

| victim_dot | SNR | IM | |
|---|---|---|---|
| X | 39 dB | −110 | dBm |
| Z | 26 dB | −77 | dBm |
| W | 40 dB | −90 | dBm |
| N | 39 dB | −96 | dBm |
| M | 21 dB | −80 | dBm |
| J | 39 dB | −87 | dBm |
| K | 40 dB | −99 | dBm |
| L | 23 dB | −120 | dBm |

Here it can be identified that RHs Z and M have low SNR measurements and high IM reports, possibly due to the UEs being closer to the cell edge than the RHs they are representing. We can also identify that RH L has low SNR measurement and low IM report, which can be the case when the representative UE is instead away from the cell edge. According to an embodiment, low-SNR measurements are discarded, and the reconfiguration can be deferred to a later opportunity. According to another embodiment, an offset can be calculated from an “acceptable SNR level” and the offset can be considered as an error bar for the IM report. In this case, IM reports for RHs Z, M and L could be [−81,−73] dBm, [−89,−71] dBm and [−127,−113] dBm, respectively, for an arbitrary acceptable SNR level of 30 dB. The method would proceed normally, always considering the two values: more conservative versions would assume IM reports are on the high end of the range, therefore assuming that coverage areas are usually more degraded and trigger reconfigurations more easily.

In a third scenario, which refers to FIG. 8, there are three cells A, B and C, wherein cell A comprises RHs W, X, Y and Z, and cell C comprises RHs H, J, K and L. In the third scenario, aggressor RHs are identified with additional measurements. As described above, the method mostly treats aggressor cells as a single transmission. Certain embodiments could, however, employ the same iterative muting procedure also on specific neighbor cells, such that IM reports would reflect the transmissions of individual RHs in the aggressor cell. Consider the following measurement table in the deployment above:

| victim_dot | SNR | IM |
|---|---|---|
| X | 39 dB | −80 dBm |
| Z | 41 dB | −78 dBm |
| W | 40 dB | −102 dBm |
| H | 39 dB | −93 dBm |
| J | 41 dB | −77 dBm |
| K | 39 dB | −84 dBm |
| L | 40 dB | −95 dBm |

This embodiment could be used to identify that RH J is interfered by both X and Z, whereas Z (and X) are only meaningfully interfered by RH J. In this scenario where RH J's coverage area forms a “wedge” into cell A, it would make sense to have RH J belong to cell A instead of cell C.

In the O-RAN Shared Cell, as shown in FIG. 2, the FHM can support multiple different cells. Thus, no rewiring or external switches are needed to move O-RUs between Shared Cells belonging to the same FHM. The decision to move O-RUs between different Shared Cells might be taken by a management entity that could reside inside the O-DU, or it could e.g., be taken in an App as part of a non-real-time RAN Intelligent Controller (non-RT RIC) in a Service Management and Orchestration (SMO) framework.

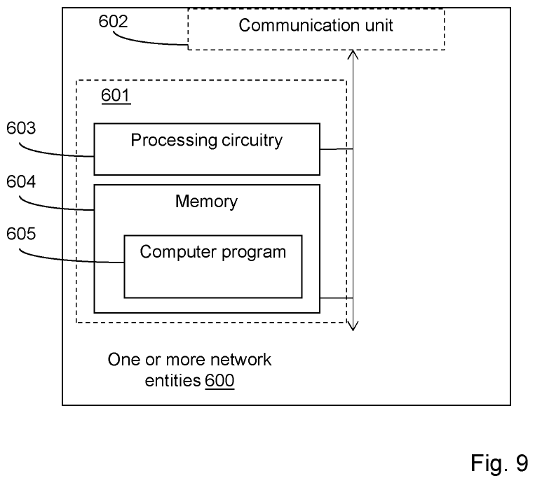

FIG. 9, in conjunction with FIG. 1 or FIG. 2, shows one or more network entities 600 configured to operate in a wireless communication network 100. The communication network comprising a base station system 110 that comprises a DU 160; 260, a Hub 130, 140, 150; 230, and a plurality of RHs 131-134, 141-144, 151-154; 231-234. The Hub 130, 140, 150; 230 is connected to the DU 160; 260. The plurality of RHs 131-134, 141-144; 231-234 are connected to the Hub 130, 140, 150; 230 via a fronthaul connection 170; 271-274. The plurality of RHs comprises a first set 131-134; 231-232 of RHs logically arranged in a first cell 135; 240 and a second set 141-144; 233-234 of RHs logically arranged in a second cell 145; 250. The one or more network entities 600 comprises a processing circuitry 603 and a memory 604. Said memory contains instructions executable by said processing circuitry, whereby the one or more network entities 600 is operative for: obtaining, for individual of the first set of RHs 131-134; 231-232, interference information on estimated interference experienced in an area served by the individual of the first set of RHs 131-134; 231-232 from signals sent by the plurality of RHs excluding the first set of RHs. The one or more network entities is further operative for determining, based on the obtained interference information, that a first RH of the first set of RHs 131-134; 231-232 suffers from intercell interference, and initiating change of the logical arrangement of the first RH from the first cell 135; 240 to the second cell 145; 250.

The one or more network entities may be part of the DU 160; 260. Alternatively, the one or more network entities may be arranged in another node of the wireless communication network, such as the network node 20 of FIG. 3. Still alternatively, the one or more network entities may be realized as a group of network nodes, wherein functionality of the one or more network entities is spread out over the group of network nodes. The group of network nodes may be different physical, or virtual, nodes of the network. The group of network nodes may be part of a cloud computing network, such as the network 30 of FIG. 3. In the system of FIG. 1, there is normally one hub per cell. In the O-RAN-based system of FIG. 2, there is normally one FHM 230 handling all, or at least a plurality of cells, but logically there is one functionality per cell.

According to an embodiment, for each of the individual of the first set of RHs 131-134; 231-232, the interference information is based on interference estimated by a set of UEs being in the area served by the individual of the first set of RHs 131-134; 231-232 on signals sent from the plurality of RHs excluding the first set of RHs and received at the set of UEs.

According to another embodiment, the signals sent by the plurality of RHs excluding the first set of RHs and onto which the interference is measured by the set of UEs are sent in first communication resources defined as first Channel State Information-Interference Measurement, CSI-IM, resources in the first cell. Further, the one or more network entities 600 is operative for instructing the set of UEs to measure interference on the first CSI-IM resources and to report the measured interference on the first CSI-IM resources to the one or more network entities. Also, the obtaining of interference information that the one or more network entities is operative, for comprises the measured interference reported on the first CSI-IM resources.

According to another embodiment, the one or more network entities 600 is further operative for, for individual of the first set of RHs 131-134; 231-232, obtaining signal strength information on an estimation on received signal strength for signals sent between individual of the set of UEs and the individual of the first set of RHs 131-134; 231-232. Further, the one or more network entities is operative for the determining that the first RH suffers from intercell interference based on the obtained interference information and on the obtained signal strength information.

According to yet another embodiment, the interference information for the individual of the first set of RHs 131-134; 231-232 is based on interference estimated by the individual of the first set of RHs 131-134; 231-232 on the signals sent from the plurality of RHs excluding the first set of RHs.

According to yet another embodiment, the plurality of RHs further comprises a third set 151-154 of RHs logically arranged in a third cell 155. The one or more network entities 600 is further operative for determining, based on the obtained interference information, that the first RH was estimated to receive higher interference from the second set of RHs 141-144; 233-234 than from the third set of RHs 151-154. Further, the one or more network entities 600 is operative for the initiation of change of the logical arrangement of the first RH from the first cell 135; 240 to the second cell 145; 250 based on the determination that the first RH was estimated to receive higher interference from the second set of RHs 141-144; 233-234 than from the third set of RHs 151-154.

According to another embodiment, the one or more network entities is further operative for, after the initiation of change of the logical arrangement of the first RH from the first cell 135; 240 to the second cell 145; 250, determining whether performance of the base station system is a above a threshold, and in case the performance of the base station is below the threshold, initiating an action with the aim to improve performance.

According to still another embodiment, wherein there are more RHs than the first set of RHs 131-134; 231-232 in the first cell 135; 240, the first set of RHs being the RHs of the first cell 135; 240 that lie closer to the cell border than the other RHs of the first cell 135; 240. Further, the one or more network entities 600 is operative for, before the obtaining of interference information, limiting a number of RHs of the first cell 135; 240 onto which to obtain information on estimated interference to the first set of RHs 131-134; 231-232 based on cell planning information of the first cell 135; 240.

According to other embodiments, the one or more network entities 600 may further comprise a communication unit 602, which may be considered to comprise conventional means for communication with other network nodes of the wireless communication network 100, such as with the base station system 110; 210. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the one or more network entities 600 to perform the steps described in any of the described embodiments of the one or more network entities 600 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the one or more network entities 600 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by one or more network entities of a wireless communication network, the communication network comprising a base station system that comprises a Digital Unit (DU), a Hub, and a plurality of Radio Heads (RH), the Hub being connected to the DU the plurality of RHs being connected to the Hub via a fronthaul connection, wherein the plurality of RHs comprises a first set of RHs logically arranged in a first cell and a second set of RHs logically arranged in a second cell, the method comprising:
obtaining, for an individual of the first set of RHs, interference information on estimated interference experienced in an area served by the individual of the first set of RHs from signals sent by the plurality of RHs excluding the first set of RHs;
determining, based on the obtained interference information, that a first RH of the first set of RHs suffers from intercell interference; and
initiating change of the logical arrangement of the first RH from the first cell to the second cell.

2. The method according to claim 1, wherein, for each of the individual of the first set of RHs, the interference information is based on interference estimated by a set of User Equipments (UEs) being in the area served by the individual of the first set of RHs on signals sent from the plurality of RHs excluding the first set of RHs and received at the set of UEs.

3. The method according to claim 2, wherein the signals sent by the plurality of RHs excluding the first set of RHs and onto which the interference is measured by the set of UEs are sent in first communication resources defined as first Channel State Information-Interference Measurement (CSI-IM), resources in the first cell, the method further comprising:
instructing (302) the set of UEs to measure interference on the first CSI-IM resources and to report the measured interference on the first CSI-IM resources to the one or more network entities, and wherein the obtained (304) interference information comprises the measured interference reported on the first CSI-IM resources.

4. The method according to claim 2, further comprising:
for the individual of the first set of RHs, obtaining signal strength information on an estimation on received signal strength for signals sent between the individual of the set of UEs and the individual of the first set of RHs, wherein the determining that the first RH suffers from intercell interference is based on the obtained interference information and the obtained signal strength information.

5. The method according to claim 1, wherein the interference information for the individual of the first set of RHs is based on interference estimated by the individual of the first set of RHs on the signals sent from the plurality of RHs excluding the first set of RHs.

6. The method according to claim 1, wherein the plurality of RHs further comprises a third set of RHs logically arranged in a third cell, the method further comprising:
determining, based on the obtained interference information, that the first RH was estimated to receive higher interference from the second set of RHs than from the third set of RHs, and wherein the initiating of change of the logical arrangement of the first RH from the first cell to the second cell is performed based on the determination that the first RH was estimated to receive higher interference from the second set of RHs than from the third set of RHs.

7. The method according to claim 1, further comprising:
after the initiation of change of the logical arrangement of the first RH from the first cell to the second cell, determining whether performance of the base station system is a above a threshold; and
in case the performance of the base station is below the threshold, initiating an action with the aim to improve performance.

8. The method according to claim 1, wherein there are more RHs than the first set of RHs in the first cell, the first set of RHs being the RHs of the first cell that lie closer to the cell border than the other RHs of the first cell, the method further comprises, before the obtaining of interference information, limiting a number of RHs of the first cell onto which to obtain information on estimated interference to the first set of RHs based on cell planning information of the first cell.

9. One or more network entities configured to operate in a wireless communication network, the communication network comprising a base station system that comprises a Digital Unit (DU), a Hub and a plurality of Radio Heads (RH), the Hub being connected to the DU the plurality of RHs being connected to the Hub via a fronthaul connection, wherein the plurality of RHs comprises a first set of RHs logically arranged in a first cell and a second set of RHs logically arranged in a second cell, the one or more network entities comprising a processing circuitry and a memory, said the memory containing instructions executable by the processing circuitry, whereby the one or more network entities is operative for:
obtaining, for an individual of the first set of RHs, interference information on estimated interference experienced in an area served by the individual of the first set of RHs from signals sent by the plurality of RHs excluding the first set of RHs;
determining, based on the obtained interference information, that a first RH of the first set of RHs suffers from intercell interference; and
initiating change of the logical arrangement of the first RH from the first cell to the second cell.

10. The one or more network entities according to claim 9, wherein, for each of the individual of the first set of RHs, the interference information is based on interference estimated by a set of User Equipments (UEs) being in the area served by the individual of the first set of RHs on signals sent from the plurality of RHs excluding the first set of RHs and received at the set of UEs.

11. The one or more network entities according to claim 10, wherein the signals sent by the plurality of RHs excluding the first set of RHs and onto which the interference is measured by the set of UEs are sent in first communication resources defined as first Channel State Information—Interference Measurement (CSI-IM) resources in the first cell, the one or more network entities further being operative for instructing the set of UEs to measure interference on the first CSI-IM resources and to report the measured interference on the first CSI-IM resources to the one or more network entities, and wherein the obtaining of interference information that the one or more network entities is operative for comprises the measured interference reported on the first CSI-IM resources.

12. The one or more network entities according to claim 10, further being operative for, for the individual of the first set of RHs, obtaining signal strength information on an estimation on received signal strength for signals sent between individual of the set of UEs and the individual of the first set of RHs, wherein the one or more network entities is operative for the determining that the first RH suffers from intercell interference based on the obtained interference information and the obtained signal strength information.

13. The one or more network entities according to claim 9, wherein the interference information for the individual of the first set of RHs is based on interference estimated by the individual of the first set of RHs on the signals sent from the plurality of RHs excluding the first set of RHs.

14. The one or more network entities according to claim 9, wherein the plurality of RHs further comprises a third set of RHs logically arranged in a third cell, the one or more network entities further being operative for:
determining, based on the obtained interference information, that the first RH was estimated to receive higher interference from the second set of RHs than from the third set of RHs; and
wherein the one or more network entities is operative for the initiation of change of the logical arrangement of the first RH from the first cell to the second cell based on the determination that the first RH was estimated to receive higher interference from the second set of RHs than from the third set of RHs.

15. The one or more network entities according to claim 9, further being operative for:
after the initiation of change of the logical arrangement of the first RH from the first cell to the second cell, determining whether performance of the base station system is a above a threshold; and
in case the performance of the base station is below the threshold, initiating an action with the aim to improve performance.

16. The one or more network entities according to claim 9, wherein there are more RHs than the first set of RHs in the first cell, the first set of RHs being the RHs of the first cell that lie closer to the cell border than the other RHs of the first cell, the one or more network entities further being operative for, before the obtaining of interference information, limiting a number of RHs of the first cell onto which to obtain information on estimated interference to the first set of RHs based on cell planning information of the first cell.

17. A computer program comprising instructions, which, when executed by at least one processing circuitry of one or more network entities of a wireless communication network, the communication network comprising a base station system that comprises a Digital Unit (DU), a Hub, and a plurality of Radio Heads (RH), the Hub being connected to the DU, the plurality of RHs being connected to the Hub via a fronthaul connection, wherein the plurality of RHs comprises a first set of RHs logically arranged in a first cell and a second set of RHs logically arranged in a second cell, causes the one or more network entities to perform the following steps:
obtaining, for an individual of the first set of RHs, interference information on estimated interference experienced in an area served by the individual of the first set of RHs from signals sent by the plurality of RHs excluding the first set of RHs;
determining, based on the obtained interference information, that a first RH of the first set of RHs suffers from intercell interference; and
initiating change of the logical arrangement of the first RH from the first cell to the second cell.

18. A carrier containing the computer program according to claim 17, wherein the carrier is one of an electronic signal, an optical signal, a radio signal, an electric signal or a computer readable storage medium.
